(19) United States
(12) Patent Application Publication
(10) Pub. No.: US 2011/0007606 A1
(43) Pub. Date: Jan. 13, 2011

(54) Underwater Surveillance

(76) Inventor: Thomas Edgar Curtis, Dorset (GB)

Correspondence Address: Ryder, Lu, Mazzeo & Konieczny LLC, PO Box 387, CONSHOHOCKEN, PA, 19428-0387, US

(21) Appl. No.: 12/918,289

(22) PCT Filed: Feb. 18, 2009
(86) PCT No.: PCT/GB09/00442

§ 371 Date: Aug. 18, 2010

(30) Foreign Application Priority Data
Feb. 18, 2008 (GB) 0802936.5

(51) Int. Cl. G01S 15/00; H04B 11/00

(52) U.S. Cl. 367/103; 367/131

(57) ABSTRACT

A counter-terrorism underwater surveillance system for detecting swimming intruders includes a sonar array 20 comprising a plurality of sensor elements which both transmit and receive acoustic signals. Power amplifiers 22 generate electric transmit signals which are converted to acoustic form for transmission by the sonar array 20. Incoming acoustic signals, including echo data from any intruder in the water, are received by the sonar array 20 and passed to a data acquisition subsystem 24, which digitises the data for processing. The digitised data is passed to a beamforming subsystem 26 which forms defined beams from omni-element data. A detection processing subsystem 28 then extracts signals from noise and reverberation and passes these to a display processing subsystem 30 which defines tracks from the intruder echo data. Finally, intruder images and tracks are displayed on a display subsystem 32. The beamforming subsystem processes outputs of the sonar array subsystem by means of a pseudo-circular convolution technique thereby to form defined beams.

This invention concerns underwater surveillance systems using sonar (sound navigation and ranging) particularly but necessarily in shallow water.

Worldwide, there are innumerable locations which demand underwater surveillance to detect swimming intruders who may be equipped with self-contained underwater breathing apparatus (SCUBA) or the like. In such locations intruder detection may be required to meet a wide variety of needs including: protecting bridges, dams, power plants, industrial installations and other waterfront facilities; monitoring port usage and/or traffic patterns; protecting docksides and channels; safeguarding shore based facilities; protecting individual vessels; portable expeditionary uses; use in permanent or otherwise fixed applications; protecting waterfront facilities; recovery of or from shipwreck, lost artefacts and other disasters; temporary border demarcation in wartime or otherwise; and counterintelligence operations. Possible intruders to which such locations may be vulnerable include, as well as thieves, enemy combatants, insurgents and terrorists.

Underwater intruder detection systems must provide sufficient resolution to distinguish an intruder who may be a single swimmer, approaching from any direction and at a distance (say 1000 m) allowing countermeasures to be implemented. In principle the design of such systems could be based upon techniques used in known minehunting systems, say, but heretofore these have employed large aperture sonar arrays and wide processing bandwidths—several hundred staves of hydrophones, wide-band coded transmissions and pulse compression processing techniques. The use of 1-3 composite ceramics facilitates the production of large-area, high-frequency sonar receiver arrays with good spatial and angular resolution and wide angular cover, and a typical system with 200 staves each quantised to 18-20 bits and processed in the frequency band 100-200 KHz can provide beams 1° wide over ±80°. However, replica correlation must be provided on each beam output for target detection, followed by overall feature extraction and image display, and the aggregate processing load presented by such real-time data acquisition, processing and display is high. Hardware throughputs as high as 5×10¹⁰ arithmetic operations per second may be needed just to implement basic time-domain digital signal processing (DSP) algorithms in real time. Substantial additional processing is required in relation to data acquisition for signal conditioning, band definition and data communications, and in practice the beamformer may need as well to perform dynamic focusing in both range and bearing in order to minimise echo smearing, and these additional processing functions may increase the DSP processing load by several orders of magnitude.

The electronic noise floor from sensor arrays as above falls well below the ambient acoustic noise floor in the ocean over the frequency bands of interest, whilst maximum signal levels are determined by the transmit source level of the system. To support both extremes it is necessary to handle dynamic ranges in excess of 100 dB so that highlight structure details (and hence the ability to classify them) of close-in bottom features are maintained. It follows that the data acquisition problem in high frequency imaging sonar systems is particularly acute.

In a paper entitled Wide band, high resolution sonar techniques presented at an IEE Colloquium (Ref No 1998/217) in 1998, I and colleagues discussed the problem of handling the high processing load demanded by large aperture sensor arrays with wide processing bandwidths required to resolve difficult targets and outlined possible solutions, for both planar and conformal arrays, based on FDFT techniques.

The conformal arrays we considered at that time were those used as flank arrays on submarines. These had a relatively small amount of curvature in the vertical and were planar in the horizontal direction. Because they were planar in the horizontal, with only limited curvature in the vertical, the array beamforming is separable, i.e. we could use a vertical beamformer on each individual stave of the confromal array, and form for each stave a fan of vertical beams. Then, for each vertical depression angle in each stave, we used a horizontal beamformer to form the full horizontal beams. The vertical beamformers (which because the number of elements in each stave were relatively small) were relatively simple and were performed using space/time beamforming techniques I had described previously in Space-Time Beamforming Using Recursive Interpolation, Proceeding of the Institute of Physics, Conference on Sonar Signal Processing, Loughborough, December, 1989. The horizontal beamformers, which were more complex because the number of staves in the array was large, used FDFT techniques.

For each array element we calculated a 64 k point FFT to get into the frequency domain. The fractional FFT beamforming algorithm was then implemented using a 256 point complex fast convolution across the elements for each frequency cell. This process generated frequency domain data, so we could implement fast replica correlation using a 64 k point vector multiply on each beam output, followed by a 64 k point IFFT for each beam to get back to the time domain.

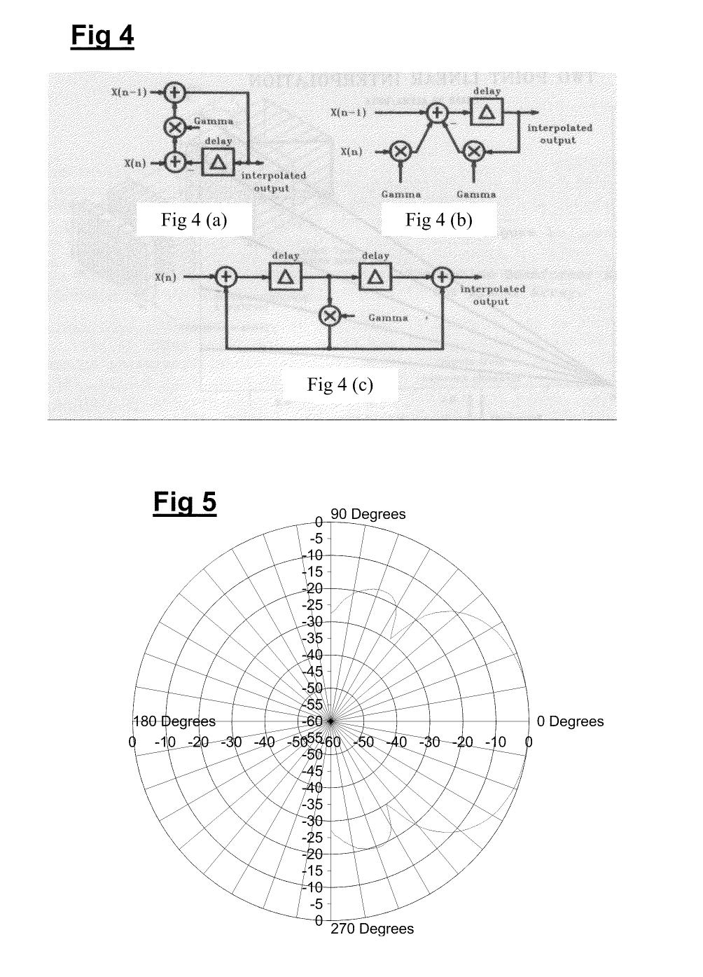

This process is shown diagrammatically in FIG. 4 of the 1998 paper and the flow is FFT, FDFT, Vector Multiply, IFFT.

It is an object of the present invention to provide improvements upon the FDFT-based approach of Wide band, high resolution sonar techniques, ibid.

Those skilled in the science will appreciate that the wide bandwidth and large dynamic range rules out the use of commercially available components for data acquisition. However, techniques based on the use of custom band-pass delta-sigma converters allow the data acquisition problem to be solved, as will now be outlined.

A low-pass sigma-delta converter was described by Boser and Wooley in The Design of Sigma-Delta Analog-to-Digital Converters, IEEE Jour SSC-23, December 1988. This converter comprises a three-port noise shaper, an analogue-to-digital converter (ADC), a digital-to-analogue converter (DAC) and a digital decimator/filter. The noise shaper is an analogue circuit configured and arranged so that the forward gain in the band of interest is very high. Thus quantisation noise introduced by the ADC is reduced at the output by the loop gain of the converter (in much the same way that output distortion is reduced in an operational amplifier by heavy negative feedback). In the converter, the oversampled ADC output data is filtered and decimated to select the required signal band, and across this band the effective dynamic range is increased over and above that of the basic ADC by the high loop gain and feedback action around the noise shaper. Applications such as those of the present invention require band-pass (that is, maximised effective dynamic range in a band of frequencies remote from dc) rather than low-pass noise shaping, and this can be achieved by first providing a low-pass noise shaper with the required bandwidth and then applying regular analogue filter low-pass to band-pass transformation techniques.

There is a possible secondary problem here. The ADC/DAC combination must be oversampled to maintain Nyquist stability around the loop, and in order to limit data transfer bandwidth some digital signal processing (DSP) is needed in the region of the converters to band-shift the element data and generate base-band signals that are oversampled no more than necessary. Those skilled in the science will be aware of various techniques to realise the band-shift/decimate process if the fractional bandwidths are small. The wider bandwiths required here call for techniques based on a combination of low complexity digital filtering, sparse multipliers and digital noise shaping.

Beamforming and detection processing in sonar surveillance systems must be able to provide sustained real-time throughputs to match the digitised element data rate. Beamforming based on space-time interpolation, as described for instance by Pridham and Mucci in A Novel Approach to Digital Beamforming, JASA, 63(2), 1978, results in an unacceptably high level of processing: for say an array of N=200 elements, with each beam needing 10×N arithmetic (multiply-accumulate) operations, to form upward of 200 beams (to provide reasonable angular cover) leads to an aggregate processing load in excess of 5×10¹⁰ operations per second. Then, with typical current DSP processors running at around 500 MHz, as many as 100 processors would be required.

Accordingly some means of reducing the processing load is called for. One possibility that may be considered is to use a 2D-FFT methodology instead of Pridham and Mucci's time domain approach. This has the potential to reduce the processing load by a factor of N²: N log N, but at the cost of additional complexity. Even with a planar array, 2D-FFT beam outputs have a maximum response axis (MRA) that is a function of frequency. The standard 2D-FFT beamformer maps from element-space to k-space rather than to beam-space, and as a result it usually has to be followed by interpolation (typically using a finite impulse response filter, 2D-FIR) to provide further mapping from k-space to beam-space. This produces beams that approximate those of an equivalent time domain beamformer insofar as the MRAs are invariant with frequency and the beamwidths decrease with frequency. But in practical terms the additional interpolation commonly results in a processing load as heavy as that of the time domain approach.

Because the discrete Fourier transform (DFT) is based on the integral roots of unity exp(−j2π/N), all FFT calculations are constrained to travel around the unit circle in the s-domain. However the 2D-FFT algorithm can be modified to allow arbitrary integration paths in the s-domain, and thereby to map directly into beam-space, by defining a fractional Fourier transform based on the fractional roots of unity exp(−j2π/N·(α), where α is arbitrary, as outlined by Bailey and Swartztrauber in The Fractional Fourier Transform and Applications, SIAM Review, Vol 33. September 1991. This fractional DFT (FDFT) can be implemented using Bluestein's Decomposition, as outlined in A Linear Filtering Approach to the Computation of the Discrete Fourier Transform, IEEE Trans Audio Electroacoust, Vol 18, 1970. Bluestein's Decomposition permits the computation of the FDFT by re-expressing it as a convolution, which can be implemented using a fast algorithm with complexity approaching that of the FFT algorithm.

The replica correlation processing load can also be reduced by use of a fast frequency domain implementation. As the beamforming process requires time-to-frequency domain and frequency-to-time domain transformations, the replica correlation process can be wrapped up into the beamforming process.

Reconciliation of the different requirements of sonar surveillance has resulted in prior systems that are large and expensive and demand substantial power supplies. But in many locations both space and power is restricted; and the widespread deployment of surveillance systems needed to cover the very large number of vulnerable locations noted above calls for cost reduction.

It is a further object of the present invention to meet the various requirements of sonar surveillance within limitations of cost, power and space and thereby provide an underwater surveillance system that can affordably be deployed in a large number of locations.

Thus according to the invention there is provided an underwater surveillance system including:

a sensor array subsystem configured and arranged for immersion in a body of water to transmit and receive sonar signals and comprising a plurality of piezoelectric elements arcuately spaced apart azimuthally around an angle θ;

a data acquisition subsystem operatively connected to the sensor array subsystem to digitise data therefrom; and

a beamforming subsystem operatively connected to the data acquisition subsystem;

characterised in that the beamforming subsystem is operative to process outputs of the sonar array subsystem by means of a pseudo-circular convolution technique thereby to form defined beams.

It will be noted that, in contrast with the approach of Wide band, high resolution sonar techniques, ibid, the present invention provides beamforming by means of a circular convolution with the array wave function, rather than an FDFT beamforming algorithm.

The beamforming subsystem preferably includes replica correlation processing operative by fast convolution of complex blocks of data from each element of the sonar array subsystem to form multiple receive beams.

Preferably the data acquisition subsystem comprises multiple continuous-time band-pass sigma-delta noise shaping modulators using multibit feedback architecture and decimated finite impulse response and wave digital filter (WDF) sections. The WDFs provide the main filtering function in the signal flow, and it is further preferred that they provide out of band rejection of greater then 120 dB, with in band ripple less than 0.1 dB and with a pass band to stop band transition bandwidth less than 4 kHz. Preferably, also, the data acquisition subsection dissipates less than 150 mW per channel whilst maintaining 20-bit precision.

Preferably the sensor array is circularly arcuate in azimuth, and θ may be 360°.

The sensor array may be divided into a plurality of sectors configured and arranged to provide a specified azimuthal spread, and each sector may have an angular dimension of 45° in azimuth.

The sensor array preferably comprises a 3-1 piezo-composite material impedance matched to the water. To provide the arcuate array the piezo-composite material may be curved by a kerfing process entailing preferentially cutting wider kerfs between the active transducer areas.

Preferably the multiple receive beams are azimuthally narrow, so that the system provides high angular resolution. For instance, the azimuthal beamwidth of each beam may be 1°. The elevational beamwidth of each beam may be 10°.

The system preferably operates at about 100 kHz and the sonar array has dimensions of about 850 mm horizontally and 100 mm vertically.

The block processing function preferably comprises the steps of (a) transforming the time-domain data block into a plurality of cells in the frequency domain by means of a 64 k point fast Fourier transform (FFT), (b) fast replica correlation by means of 64 k point vector multiplication of each of the frequency domain data block outputs, (c) fast convolution by means of a 512 point complex fractional FFT or pseudo-circular convolution implemented across the elements for each frequency cell, thereby to generate frequency domain beam data, and (d) 64 k point inverse FFT (IFFT) to return to the time domain.

The data acquisition subsystem preferably includes digital filtering and decimation, which may be implemented in field-programmable gate array (FPGA) form.

The underwater surveillance system preferably includes a power amplification subsystem operatively connected to the sensor array subsystem and configured and arranged to deliver thereto at least 215 dB relative to μPa at 1 m.

The system preferably includes a detection processing system operatively connected to the beamforming subsystem and configured and arranged to extract intruder echo data from noise and reverberation.

The system preferably includes a display processing subsystem operatively connected to the detection processing subsystem and operative to define tracks from the intruder echo data.

The system preferably includes a display subsystem operatively connected to the display processing subsystem to display intruder images and tracks.

Other features of the invention will be apparent from the following description, which is made by way of example only with reference to the accompanying schematic drawings in which—

FIG. 1 illustrates the geometry of a cylindrical array of sensors B;

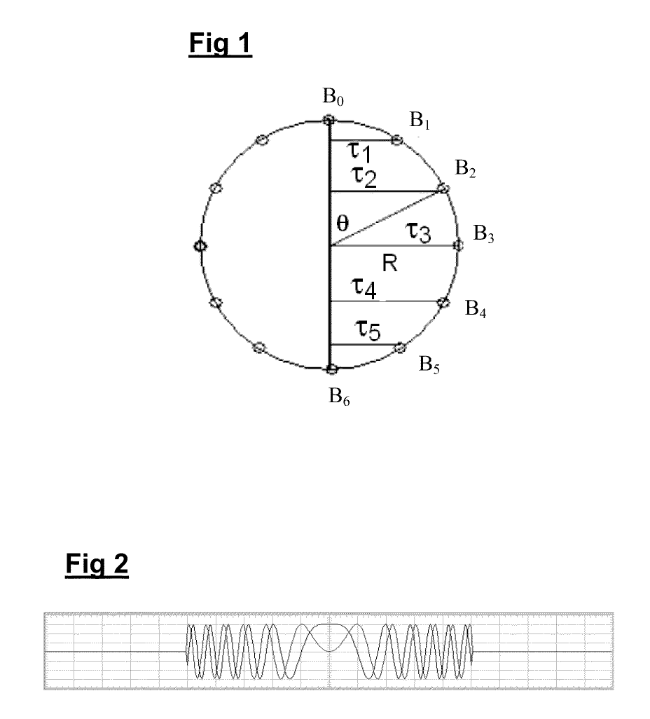

FIG. 2 illustrates, for the array of FIG. 1, a complex array wave function for a source at broadside;

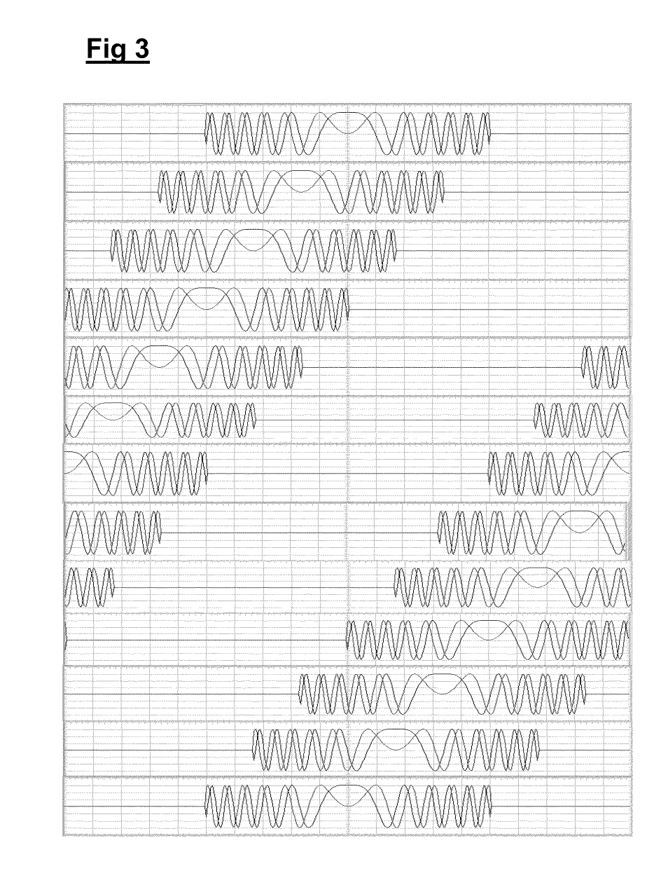

FIG. 3 illustrates, for the array of FIG. 1, complex array wave functions for a source rotated in 30° increments from broadside through to broadside;

FIG. 4 shows an all wave digital filter interpolation schematic and transfer function for space-time interpolation using recursive interpolation;

FIG. 5 shows a measured transducer element azimuth beam pattern;

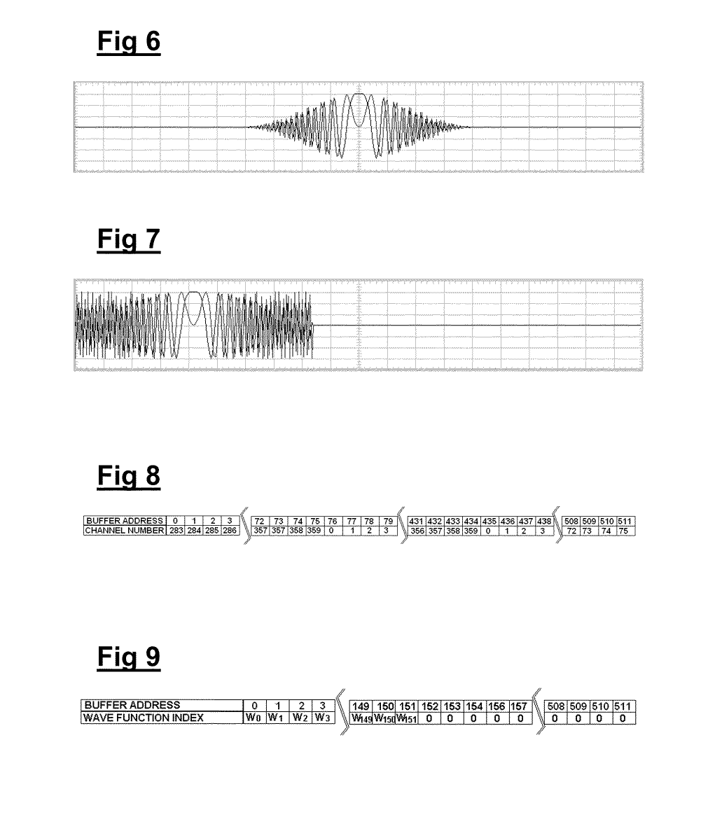

FIG. 6 shows an array wave function corresponding to the measured beam pattern of FIG. 5;

FIG. 7 shows the truncated 152-point array wave function used for beam forming;

FIG. 8 is the FFT buffer modulo 360 address mapping showing channel number to FFT input buffer address mapping for pseudo 360-point convolution;

FIG. 9 is the FFT input buffer linear address mapping showing a wave function index to FFT input buffer address mapping for beamforming convolution reference generation;

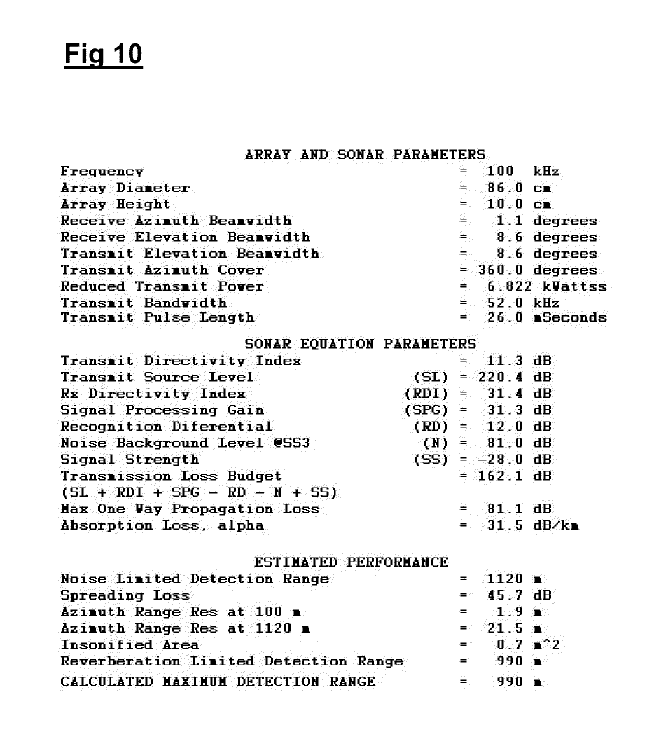

FIG. 10 summarises key parameters for an underwater intruder detection system according to the invention, which parameters are derived from detailed modelling of the system and a harbour/port environment;

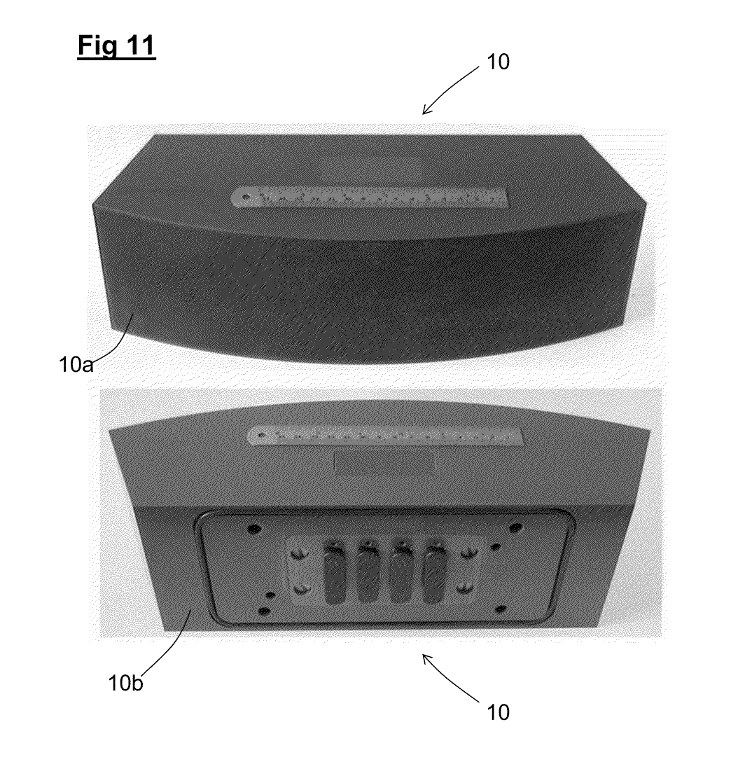

FIG. 11 illustrates a sector of a sensor array;

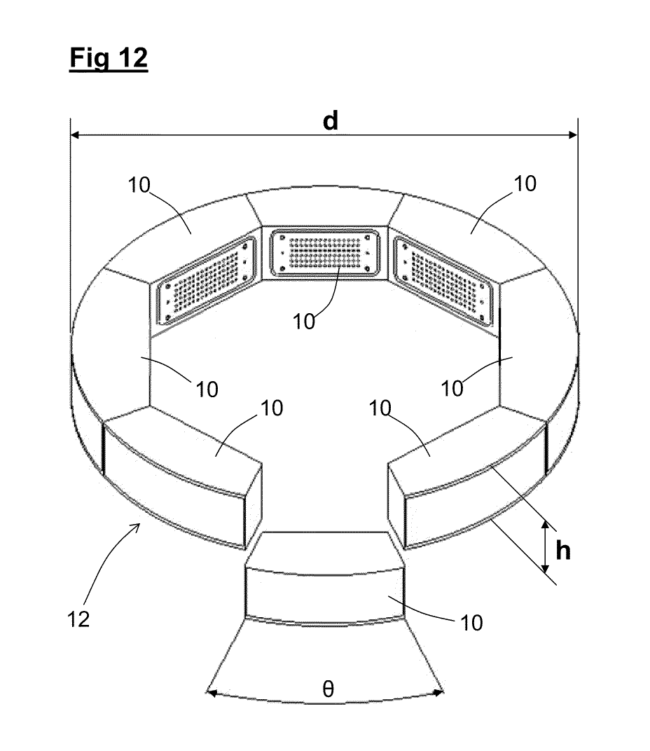

FIG. 12 shows a plurality of sectors as in FIG. 11 assembled together to form a cylindrical sensor array;

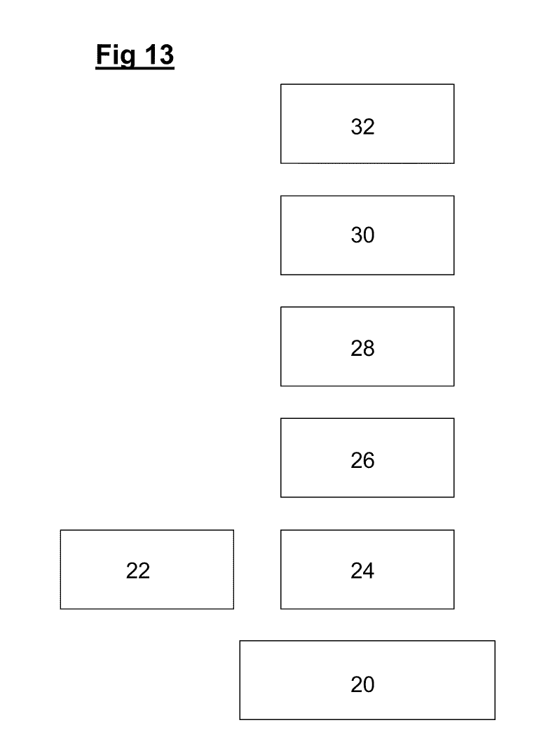

FIG. 13 is a top-level block schematic illustration outlining a surveillance system according to the invention;

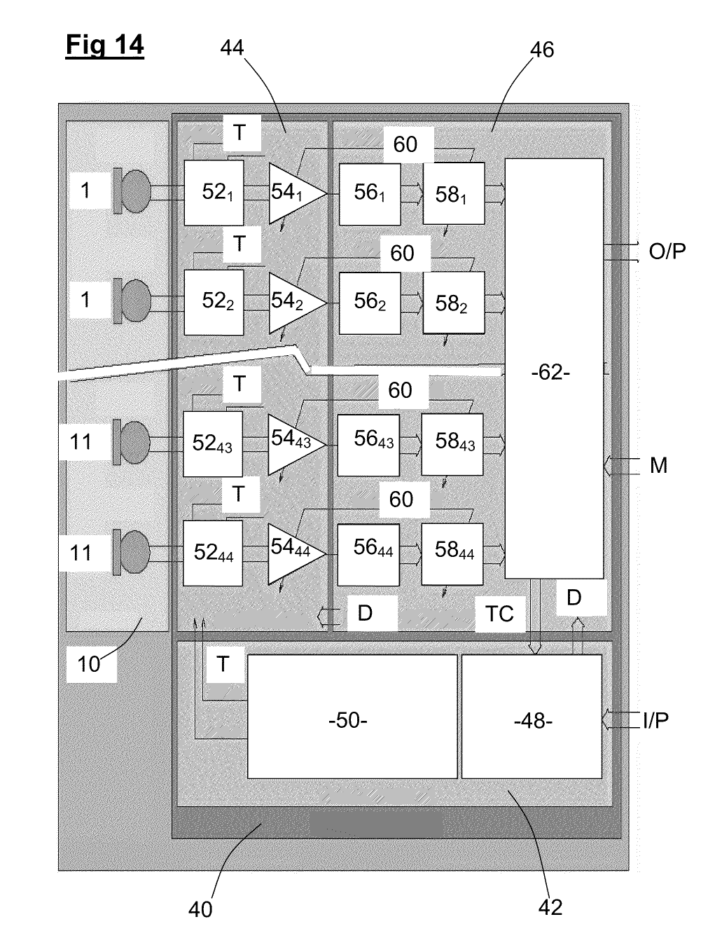

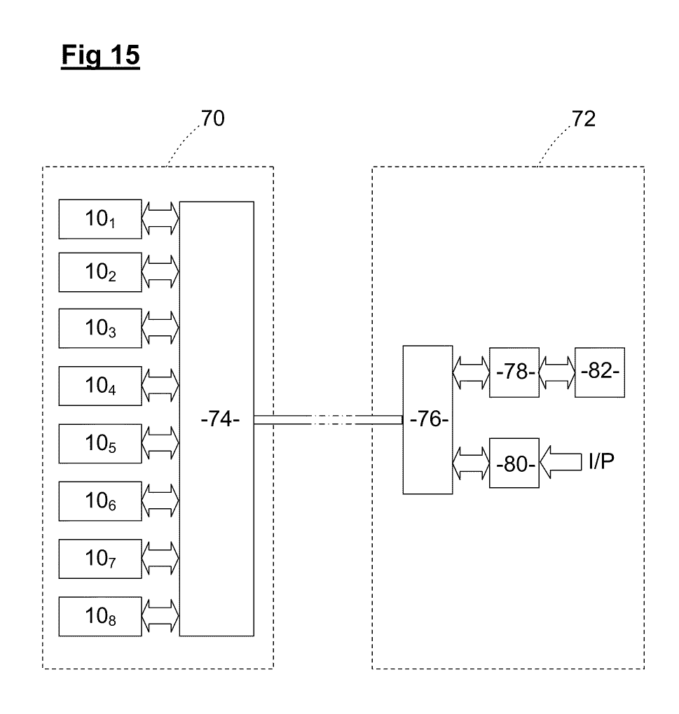

FIG. 14 is a more detailed block schematic illustration of the system showing multiple array elements;

FIG. 15 is a block schematic illustration distinguishing the wet end (in the water) from the dry end (out of the water);

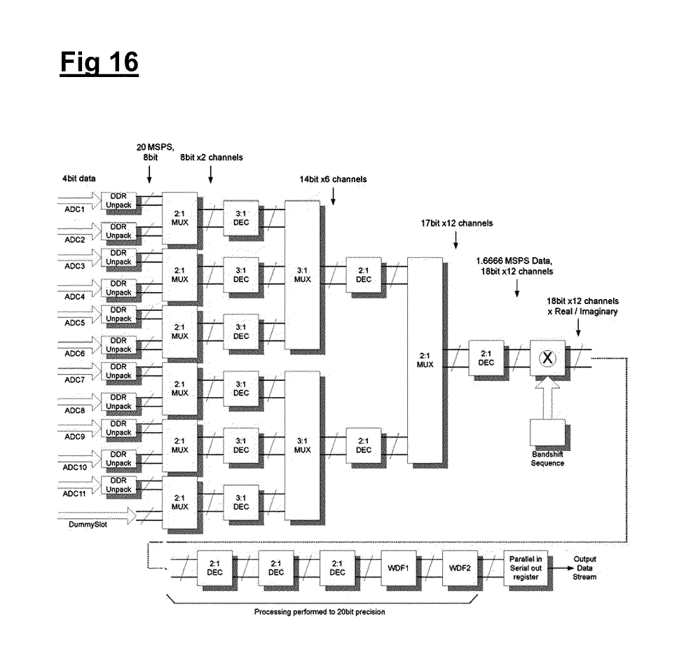

FIG. 16 illustrates filtering, bandshifting and decimation in a system according to the invention;

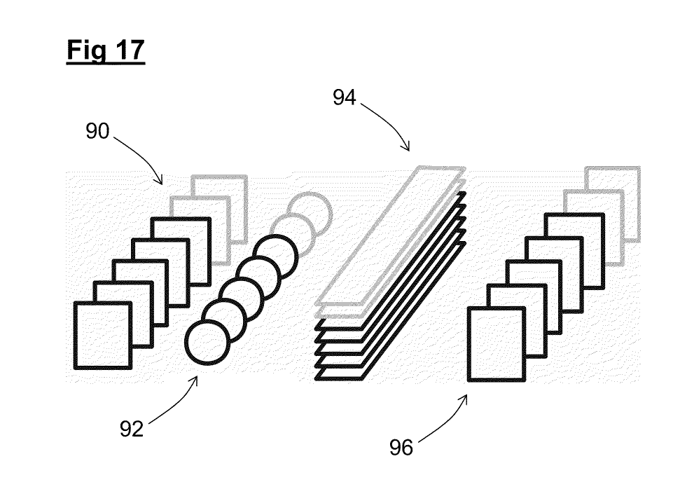

FIG. 17 illustrates beamforming and signal processing in a system according to the invention;

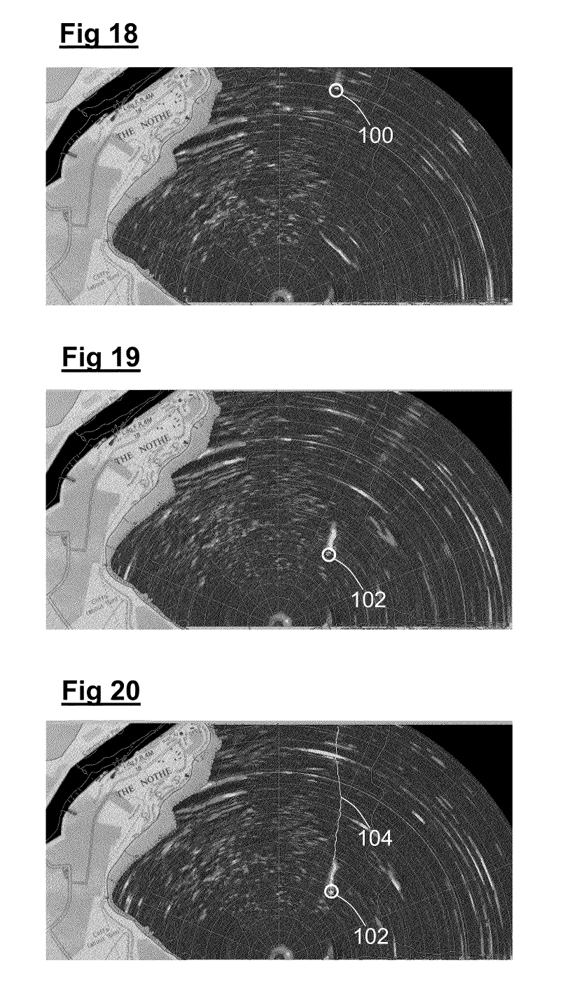

FIG. 18 illustrates a display taken from a test of a system according to the invention showing detection of a diver equipped with closed circuit rebreather SCUBA at a range of about 800 m;

FIG. 19 illustrates a display like that of FIG. 12, showing the diver at a range of about 300 m; and

FIG. 20 illustrates a display showing the track of the diver from the position of FIG. 18 to that of FIG. 19.

A beamformer equation for producing a beam in a particular direction from an array of sensors can be written as:

$${A}_{r} ( t ) = {\sum }_{k = 0}^{N - 1} {S}_{k} \cdot {B}_{k} ( t + {τ}_{r , k} ) \qquad ( 1 )$$

where
Aᵣ(t) is the beamformer output for the r^{th} beam in a fan thereof.
Sₖ is the array weighting function applied to the kt^{h} sensor
Bₖ (t) is the time domain signal received at the kt^{h} sensor
τ_{t,k} is the time delay applied to the signal from the k^{th} sensor to form the r^{th} beam in the fan.

For a cylindrical array of sensors B as shown in FIG. 1, the compensating time delay, τ_{r,k}, for a beam r pointing to the right as seen in FIG. 1 can be derived from the geometry as:

τₖ=R/c·sin(θₖ) (2)

If Bₖ(t) is a narrowband process, corresponding to some frequency ω, we can express the beamforming operation as a phase delay, rather than a time delay process, in the form:

$$\begin{matrix}{A}_{r} ( t ) = {\sum }_{k = 0}^{N - 1} {S}_{k} \cdot {B}_{k} ( ω t + {φ}_{r , k} ) & ( 3 ) \\ = {\sum }_{k = 0}^{N - 1} {S}_{k} \cdot {B}_{k} ( ω t ) \cdot exp ( {jφ}_{r , k} ) & ( 4 )\end{matrix}$$

The equivalent phase delay for the cylindrical array configuration can be expressed as:

exp(jφₖ)=cos(R/c·sin(θₖ))+j sin(R/c·sin(θₖ)) (5)

In practice, the elements themselves have some defined horizontal beam pattern that modifies the spatial extent of the “wave function” chirp. This may be due to the way the transducers are mounted onto the array structure or it may be due to the actual design of the element itself. In the limit, for a typical system where the array mounting forms an acoustic baffle, the element response could extend though ±90°. Applying this ±90° constraint and plotting Equation (5) above for an array with a moderate number of transducers and with linear spacing less then λ/2 at frequency ω, reveals phase compensation in the form of a complex spatial chirp, as indicated by FIG. 2.

Moving a source around the array, the spatial chirp (or the array “wave function”) remains the same shape but rotates around the array in sympathy to the source rotation. That is to say, the shape of the wave function is rotationally invariant. However the null position of the chirp indicates the direction of the source, as illustrated in FIG. 3 for a source rotated in discrete 30° increments around the array. It follows that, by generating this phase correction chirp and applying it to the array element data to form a beam, additional beams can be produced by rotating the same chirp function around the array and calculating the beam summation defined by equation (4) for each required direction.

This process effectively calculates the circular convolution of the wave function chirp with a snapshot of the narrow-band array data. The mathematical properties of this convolution process can be used to simplify the practical implementation of the beamformer, as will now be discussed.

It is well known that circular convolution in the time domain is equivalent to vector multiplication in the frequency domain. Therefore it is possible (a) to transform a snapshot of the N array element time domain data samples into the frequency domain, using an N-point discrete Fourier transform (DFT), (b) to transform the N-point phase chirp into the frequency domain, again with an N-point DFT, (c) multiply the two resultant frequency domain vectors pointwise together, and then (d) transform the resulting N-point product vector back into the time domain, using an N-point inverse DFT. This generates a snapshot of a fan of N time domain beams. This process can be performed on successive snapshots of the array data, taken at some sample rate faster then the Nyquist rate, to form a continuous time series of the beam formed data. See Farrier et al in Fast Beamforming Techniques for Circular Arrays, J Acoust Soc Am, Vol 58, No 4, October 1975 and DeMuth in Frequency Domain Beamforming Techniques, XXX, 1976

A problem with implementing the above algorithm as a low complexity beamformer is that the transform length, N, has to match the number of elements in the array, and the manipulation generates a fan of N beams. This process can be carried out efficiently if the number of elements and beams is given by 2n, for example when there are 256 or 512 elements in the cylindrical array, when the DFT and inverse DFT can be calculated using Fast Fourier Transform (FFT) techniques. Unfortunately, in many practical applications, the constraint N=2ⁿ causes other problems: for example, it is convenient to use an element spacing in the array equal to 1°, giving N=360, but this length transform cannot be calculated directly using the FFT.

However, the DFT block length N (360 in the above problematic example) can be rewritten as the product (8×9×5), allowing implementation of the 360-point transform using cascaded small length DFTs, ie of lengths 8 points, 9 points and 5 points. This can be achieved using decomposition detailed by Good in The Interaction Algorithm and Practical Fourier Series, J Roy Statist Soc, Ser B, Vol 20, 361-372, 1958, to partition the matrix processing into three distinct passes and, as the small DFT block lengths are relatively prime, use the Chinese remainder theorem, (first detailed in Sun Tzu Suan Ching circa 300 AD) to minimise the amount of calculation required, by eliminating the inter-pass twiddle factor multiplications.

The foregoing approach has been used in both custom hardware and FPGA based implementations, using low complexity transform techniques detailed in Spreadbury and Curtis in International Patent Application WO87/07053, the contents whereof are hereby imported by reference. This provides cost-effective solutions for stand-alone, battery-powered underwater intruder detection systems intended for portable expeditionary deployment.

However, for more general and widespread use in harbour and port protection, it is preferable to perform all the beamforming and signal processing on an inexpensive and generally available personal computer (PC). Whilst the address sequence complexity required to code small length relatively prime transforms comes for free using the massive interconnection resources available on FPGAs, this becomes a prohibitive overhead when such algorithms are mapped onto PC CPU cores. It is therefore necessary to find a way to implement these circular convolutions using standard library calls to efficient FFT routines, in order to implement these algorithms efficiently on current generation commercial CPU cores. By this means the invention can provide a low cost, compact sonar surveillance system capable of protecting high value targets from assymetric attack by swimmers, divers and the like.

Consider an array in which the transducer elements are angularly spaced apart at 1° intervals. For the maximum system configuration, we use a fully filled cylindrical array, with nominally 360 transducers (although some of these are interpolated data where elements between the 45 degree sector arrays are of necessity omitted as will be explained in more detail hereinafter).

It is necessary to map these 360 channels of element data efficiently onto a set of standard high performance primitives that support efficient realisation of signal processing functions on current generation desktop CPU cores. In short, the system has to support 360 point circular convolution on a 512 point FFT.

Two practical solutions to this problem are element space interpolation and pseudo-circular convolution, each of which possibilities will now be discussed in turn.

First, with regard to element space interpolation, the 360 element cylindrical array data can be spatially interpolated to generate what is effectively a 512-point cylindrical array. This interpolation itself can be organised in several ways, either using a sparse spatial FIR or by using wave digital filter (WDF) interpolation.

Typically, for the spatial FIR interpolator, it is necessary to calculate an 8 point interpolation for each of the 512 output data points, requiring just one pass through the data and using 4096 complex multiplies and adds (equating to 16384 real multiplies and 8192 adds).

With the WDF approach, all pass sections can be arranged to provide interpolation ratios given by some integer value, e.g. ×2, ×3, etc. Thus the minimum sized integer interpolation/decimation ratios that can be implemented in this way are an (interpolate by 64)/(decimate by 45) function: that is, the integer fraction 64/45 represents the LCM quotient/divisor that can be supported. This 64/45 interpolation ratio is most conveniently implemented by a factoring process as follows using:
interpolation by 64=4×4×4
and decimation by 45=3×3×5.

Hence, the interpolation/decimation process flow can then be interleaved, to minimise the process steps, as:
(A) Interpolate by 4/decimate by 3
(B) Interpolate by 4/decimate by 3
(C) Interpolate by 4/decimate by 5

The interpolate by 4 process can itself be reduced to two cascaded interpolate by 2 processes and then the complete process reduces to a continued application of an identical interpolate by two process, interspersed at intervals by a decimation, which simply requires a data selection process. For example, to decimate by 3, save only every 3_{rd} point from the interpolators, and discard all other samples. For decimation by 5, only every 5^{th} point is saved.

It follows that the interpolate by 2 process is the only operation that requires arithmetic number crunching. It can be realised effectively using a WDF structure using just one binary shift and two add operations per interpolated data point, so it is a very low complexity process. The interpolate function is performed using all pass WDF sections, which each generate an interpolated data point, as I described in Space-Time Beamforming Using Recursive Interpolation, ibid.

The above process is illustrated schematically in FIG. 4, together with the z-domain transfer functions generated.

Overall, the process requires three passes through the element data to complete the full interpolation processing, requiring a total of 23680 adds.

For both FIR and WDF, the resultant 512-point effective array is forward transformed, multiplied by a transformed replica of the array wave function, and inverse transformed to generate a fan of 512 contiguous beams. The complete process is then repeated for each frequency cell in sequence in the 64 k cell spectral data block.

Pseudo-circular convolution involves modifying the data address sequence that transfers the 360-points of element data into the 512-point FFT input buffer store, so that the data points are themselves organised to repeat modulo 360 in the buffer. Then it is possible to select just that part of the 512-point circular convolution that provides an unambiguous 360-point circular convolution. This is achieved as follows.

First, consider by way of example a cylindrical array of P transducers, from which it is wished to form a fan of P beams, using an arc of the array comprising Q hydrophones. The wave function examples considered above to illustrate the circular convolution approach to cylindrical array beamforming used an arc length equal to P/2 elements. If this arc length is to maintained, then in order to obtain a true circular convolution from a non-P point FFT, it would be necessary to use an FFT length, N, greater than (P+P/2). Thus the case of P=360 demands an FFT length greater than 540, i.e. an FFT block length, N=1204. However, as noted previously herein, in a practical array the actual arc length possible is a function of the horizontal beam shape of the individual array elements.

Thus the minimal size FFT that could support a 360-point circular convolution leads to an inequality:

(360+Q)<512

or

Q<152

Accordingly, if the natural beam shape of the individual transducer elements in the array is contained within 152 degrees of azimuth, it is possible to use a 512-point FFT to calculate a 360-point circular convolution. In practical 1-3 composite arrays, this constraint is usually met, as the requirement for a λ/4 matching layer to maximise energy transfer between the array and the medium results in azimuth beamwidths typically well contained within 152°, as shown in FIG. 5.

This produces practical array wave function as shown in FIGS. 6 and 7.

The beamforming process is then organised into four stages as follows:
(a) (a) The 360-points of element data defining data from elements 0 through 359 are written to locations 76 through 435 of the 512-point FFT input buffer. The data from elements 0 through 75 is then repeated in locations 436 to 511 of the buffer and data from element 283 through 359 in buffer store locations 0 through 75 (i.e. the buffer store is loaded with element data using an address sequence calculated modulo 360, as shown in FIG. 8). Logically this process can be described by the algorithm:

For count:=0 to 511 do

Buffer[count]:=Element[(count+283) mod 360)]

(b) The 512-point complex data block in the buffer is forward transformed using a 512-point FFT algorithm.
(c) The resultant vector is multiplied pointwise with a transformed version of the wave function. (This is generated off line, by padding the 152-point complex wave function data with 360 zeros, as illustrated in FIG. 9, and forward transforming that vector).
(d) The 512-point complex vector product is inverse transformed and the first 360 points of the vector that represent the unambiguous circular convolution are selected.

The process has been described above for P=360 and Q=152, but those skilled in the science will appreciate that it can be generalised for smaller values of Q if required.

Other methods may also be used to support 360 point circular convolution on a 512 point FFT. The beamforming algorithm described above in relation to pseudo-circular convolution is efficient in that application if and only if Q≦152. If Q>152, then it is necessary either to migrate up to the next available FFT size (ie to 1024 points) and accept a loss in efficiency or to use a fractional FFT algorithm to allow direct implementation of 360-point circular convolutions by means of Bluestien's Correspondence to implement these using 512 point FFTs. The relative efficiency of this vis-à-vis the 1024-point transform approach is dependent on FFT efficiency.

Target echo highlights seen from a swimmer are generated mainly by reflections from internal air cavities such as the lungs and other body cavities, from exhaled air bubbles and from compressed air tanks where SCUBA is used. These highlights show up best using frequencies around 100 kHz.

Harbour surveillance systems must be able to detect intruders in reverberant conditions, such as the cluttered shallow water environments normally encountered in harbours and the like. This requirement leads to a design using narrow receive beams with wide frequency bandwidth centred around 100 kHz, and the use of large bandwidth×time (BT) product coded transmissions, to combat the effects of reverberation and detect targets against the reverberant background. As well as providing good angular resolution on receive, it is necessary to ensure a wide angle of cover to detect threats coming from all directions. This requires an omni-directional transmit system that supports wide bandwidth, high BT coded pulses and a receive system that generates a fan of contiguous narrow beams to detect against the low target strength targets against the reverberant background. This requirement for omni-directional transmission, with a narrow beam receive system leads to the use of a cylindrical array topology as the natural “geometry of choice” for such a system. Such a cylindrical array would comprise a plurality of vertical staves with essentially an omni-directional response in the azimuthal (horizontal) axis but with some defined directivity in the elevational (vertical) axis.

The surveillance system must provide sufficient warning time when intruders are detected, to allow time for countermeasures to be deployed. For a typical attack swimmer, using a covert closed cycle rebreathing apparatus, and swimming at an average speed of say 0.25 m/s to 0.50 m/s, a 30 min alert time demands that intruders be detected at a range between 450 m and 900 m.

Those skilled in the science will also appreciate that, as well as the normal spreading losses that occur when acoustic waves travel through water, there are additional losses due to absorption effects. These absorption losses are a strong function of frequency and severely limit the possible detection ranges in high frequency sonar systems. For example, absorption loss is typically around 30 dB/km at 100 kHz, rising to around 100 dB/km at 300 kHz. For a typical detection range of say 800 metres, therefore, absorption loss will be around 50 dB at 100 kHz, rising to around 170 dB at 300 kHz. It follows that the working frequency of 100 kHz which provides the best target echo highlights as noted above also provides favourable absorption loss in comparison with higher frequencies.

Using the basic parameters outlined above for detection range and sonar characteristics, together with typical values for intruder target strength, allows predicted sonar performance to be modelled for various sonar configurations and selection of a system configuration that is well matched to the basic performance requirements.

The predicted performance of a system using a 360° 1-3 composite array was modelled for a harbour environment by means of simulation software. The results are shown in FIG. 10, which shows calculated propagation loss budget and detection range for a source level of 220.4 dB and a transmit pulse rate of 2 s. FIG. 10 lists array and sonar parameters, sonar equation parameters and estimated performance figures. On the basis of this modelling, a receive array of the order of 850 mm diameter and 100 mm height, capable of supporting high transmit source levels using high BT product coded transmissions, can provide the required level of surveillance over 360° up to a range of between 990 m and 1120 m. The average supply power is 184.8 W.

The development of a practical underwater surveillance system from the model parameters of FIG. 10 will now be discussed, beginning with the array technology.

In a sonar array for a system according to the present invention, with the frequencies and bandwidths indicated, it is necessary first of all to choose between polyvinylidene fluoride (PVDF) polymer and ceramic piezo-composite technology. (Whilst it is possible to produce sensors using arrays of conventional miniature transducers, the transducer-to-transducer matching that can be achieved in this way is nowhere near as good as that produced by the batch production techniques used with either PVDF or piezo-composite. Also the costs in “hand-crafting” very small individual hydrophones are excessive. The need for wide bandwidth from the array militates against the use of a conventional piston based design, because evaluation has shown that it is difficult to provide a bandwidth approaching 20 kHz at a 100 kHz centre frequency with this form of transducer).

From assessment of prototype arrays, PVDF appears to offer a low cost solution, but the technology is at this time somewhat immature. Further, trials of PVDF suggest there may be problems in de-poling of the polymer at elevated operational temperatures and also problems with producing viable source levels.

By contrast, piezo-ceramic technology has been well proven over 30 years or more and is commercially available from a variety of sources. Accordingly a piezo-ceramic array is preferred herein (although it should be noted that this preference is not a limitation on the present invention, which is defined by the claims set out hereinafter).

To minimise cost in the present invention, the same array is used for both transmit and receive. This leads to a number of refinements in the base technology to provide a large cylindrical array that can support source levels in excess of 220 dB re uPa @ 1m, with bandwidths of 40 kHz or more centred on 100 kHz, whilst maintaining high receive sensitivity.

An array meeting a basic specification derived from the sonar system modelling is available from Alba Ultrasound Limited of Glasgow, UK. An array manufactured by them and used in the invention comprises a plurality of 45° sector modules that can be assembled contiguously to provide a full circle (and can also, by selective operation, provide angular cover from say 90° degrees to 360°. This modular arrangement allows more flexibility than an integral 360° array.

FIG. 11 shows two views of a 45° sector module 10, respectively from the front (that is, showing the arcuate, outwardly-directed face 10a of the module 10) and from the rear (which has a substantially planar face 10b). The vertical dimension of the module is about 100 mm, and the arcuate front face 10a is about 340 mm long along the arc.

Referring now to FIG. 12, eight modules 10 of the kind shown in FIG. 11 are assembled together side-by-side to form a full 360° array indicated generally at 12. (The forward one of the modules 10 as seen in FIG. 12 is drawn out of the circle to show that it comprises a slice of the complete ring). Each module 10 has an angular dimension θ=45° and a vertical dimension h≈100 mm. The whole array 12 has an overall diameter d≈850 mm.

Whilst each module 10 has an angular dimension of 45°, in fact it comprises 44 sensors each having a wide beamwidth in azimuth (and 10° in elevation) angularly spaced apart at 1° increments. This is because physical limitations make it necessary to omit one sensor per module (i.e. 44 sensors instead of 45) to provide space to accommodate the array housing. However, the effect of the omitted elements can be compensated in the sonar signal processing electronics to minimise the effect on the sonar beampattern.

Acoustic tank measurements show that the array module 10 provides the 44 elements with individual gain and phase matching within 0.5 dB and 2° rms respectively, and that the module 10 can support in excess of 40 kHz bandwidth and also provide source levels in excess of 220 dB.

Moving on now to signal processing, an elementary schematic for implementing the required signal processing flow is shown in FIG. 13. (It should be pointed out that this schematic is very general, and by no means unique to the present invention, but it will nevertheless help the invention to be understood).

Insofar as the array comprises a plurality of 45° sector modules, it is convenient for the electronic processing components needed in close proximity to the array to be similarly quantised. That is to say, the electronics processing data in the “wet end” of the system is configured and arranged to map on to the modular structure of the array itself, with 44 elements spread over 45°.

It is also preferred to minimise the amount of electronics needed in the wet end of the system and to perform as much as possible of the sonar processing at the surface (in the so-called “dry end”). The processed data from the array modules are combined in a central hub that supports a wide band fibre optic umbilical link cable for data transmission and control to and from the dry end. The hub also provides power line conditioning, from the copper power feed contained in the umbilical, to provide dc power to the wet end electronics. This wet end/dry end split minimises the overall system cost and allows maximum flexibility in providing various configurations of the system for disparate operational deployment scenarios.

FIG. 13 provides an overview of an underwater surveillance system according to the invention. At the heart of the system is an underwater sensor array 20 comprising a plurality of sensor elements which both transmit and receive acoustic signals. Power amplifiers 22 generate electric transmit signals which are converted to acoustic form for transmission by the sensor array 20. Incoming acoustic signals, including echo data from any intruder in the water, are received by the sensor array 20 and passed to a data acquisition subsystem 24, which digitises the data for processing. The digitised data is passed to a beamforming subsystem 26 which forms defined beams from quasi-omnidirectional element data. A detection processing subsystem 28 then extracts signals from noise and reverberation and passes these to a display processing subsystem 30 which defines tracks from the intruder echo data. Finally, intruder images and tracks are displayed by a display subsystem 32.

The wet end processing module is as shown in the schematic in FIG. 14. The electronic circuits defined in this schematic were manufactured in the form of a compact unit that mounts directly behind the array module, to minimise the inevitable electronic noise and interference inherent in such compact devices.

Referring now to FIG. 14, this shows an array module 10 (like that shown in FIGS. 11 and 12) in juxtaposition to an associated electronics assembly 40. The array module 10 is equipped with forty-four hydrophone elements 11₁, 11₂ . . . 11₄₃ and 11₄₄. The electronics assembly 40 a transmit unit 42, a preamplifier unit 44 and an ADC and filter unit 46.

In the transmit unit 42 a power conditioning and DC link converter 48 receives power input and control I/P and delivers DC power to the ADC and filter unit 46. DC power is in turn delivered from the ADC and filter unit 46 to the preamplifier unit 44. The transmit unit also includes a transmit waveform generator and power amplifier 50 which delivers transmit and Tx signals T to the preamplifier unit 44.

The transmit and Tx signals are fed to forty-four T/R switches 52₁, 52₂ . . . 52₄₃ and 52₄₄, one for each of the hydrophone elements 11₁ to 11₄₄, each with an associated preamplifier 54₁, 54₂ . . . 54₄₃ and 54₄₄. The preamplifiers 54₁ to 54₄₄ feed respective ADCs 56₁ to 56₄₄ in the ADC and filter unit 46 The ADCs 56₁ to 56₄₄ feed respective switch gain compensate devices ADCs 58₁ to 58₄₄ which are in turn linked by 24 dB gain switch control 60 to the respective preamplifiers 54₁ to 54₄₄.

The switch gain compensate devices feed a common multiplexing, filtering and decimation device 62. This device 62 delivers module output O/P to signal processing (not shown in FIG. 14) and receives module control MC from signal processing. To complete the control loop, the multiplexing, filtering and decimation device 62 also delivers Tx control TC to the power conditioning and DC link converter 48

FIG. 15 shows the hub/umbilical schematic. The processing is divided between the wet end and the dry end indicated in broken lines at 70 and 72. The wet end 70 comprises eight array modules 10₁ to 10₈ interconnected with a hub data concentrator 74. In the dry end 72 a top end interface 76 is interconnected with a sonar interface 78 and a cable power interface 80 which receives power input I/P for the system. Also in the dry end 72 a sonar DSP and display unit 82 is interconnected with the sonar interface 78. The wet end 70 and the dry end 72 are linked by an umbilical cable 84.

In more detail, the wet end of the system provides a number of functions as follows.

First, the wet end includes a transmitter to provide the high BT product transmit waveform. This is driven into all the sensor transducers in parallel during the transmit period to provide an omni-directional transmission from the 8 module system (or a transmit cover in increments of 45 degrees for system using fewer modules). The power produced by this transmit amplifier module is necessarily high, to provide the required source level (up to 5 kW per module). To make sure that the transmitter would work correctly with a high loop resistance power feed provided by the umbilical, the power taken by the transmit system is spread throughout the complete receive cycle (as outlined below), and the umbilical is effectively isolated from the receive subsystem (to avoid “frying” it) by logically interlocking the power amplifier control system so that transmit signals can only be generated when the transmit/receive switch is in a safe position, thereby isolating the receive circuits from the transmit power chain.

The transmitter module itself provides a number of different functions. The power for the module input is provided via a copper feed from the umbilical, at a nominal 115 volts, 60 Hz. The front end of the power amplifier implements a current limited charge pump that charges local high density storage capacitors to provide a nominal 400 volt dc link supply. The energy for the transmission is provided from these storage capacitors, and these are trickle charged at the rate of around 0.5 amps between transmissions. This approach is used to spread the peak power demand for the high power transmissions over the complete receive cycle, thus allowing the use of much lower rated (and hence cheaper and smaller) copper cable in the umbilical. The dc link supply feeds to the power output stage, a conventional class D system using an H-bridge topology, realised using third generation Insulated Gate Bipolar Devices (IGBT) with silicon carbide reverse energy recovery diodes. This combination provides a very high efficiency, rugged output stage. The bridge output feeds to the transmit/receive switches via an L-C matching network that minimises the imaginary part of the complex transducer load impedance over the required frequency band, and hence maximise power transfer to the array.

The transmit/receive switch (T/R switch) provides a path for the transmit power to get from the power amplifier to the 44 individual transducers during the transmit period. Also at this time it isolates the receive system from the transducer to avoid overstressing the sensitive front end pre-amplifiers with the large voltage needed for transmission (around 1500 volt peak to peak). During the receive period, the T/R switch connects the 44 individual transducers to their respective low noise pre-amplifiers: the signal levels seen at this point are of the order of a few tens of nano-volts. So, it can be appreciated that the T/R switch has a major role in the system operation, needing to stand off up to ±1 kV during transmission whilst passing a signal level of a few tens of nano-volts during the receive period.

The pre-amplifiers interface to the essentially capacitive transducer source and provide a low noise charge amplifier scheme to amplify the received signals to sufficient level to feed the following analogue-to-digital converters (ADCs). The pre-amplifiers provide a switched gain circuit that is controlled from the surface electronics, to allow the system gain to be modified during the receive period, if necessary. The pre-amplifier circuits also contain an inject facility that allows test signals to be injected, on command from the top system electronics, into the analogue data path close to the front end of the system to check out system performance in real time. This allows the operator to perform system confidence checks and to determine the state of the particular transducers in the array. The inject Built In Test (BITE) system provides the input to allow the signal processing software to compensate for failed or faulty channels.

The ADCs convert the analogue signals from the preamplifiers into digital signals for signal processing. The ADCs use a proprietary continuous time, heavily over-sampled noise shaping modulator to provide a large dynamic range with minimal hardware complexity. This approach was used instead of design using “off the shelf” silicon integrated circuits in order to minimise the system power whilst at the same time maintaining adequate system dynamic range. The ADCs basically quantise the signal data at a 20 MHz rate, using an 8-bit word length. The noise shaping is used to shape the quantisation noise spectrum in order to maximise the signal to quantisation noise across the receive band. This band is then filtered out in the following signal processing, to provide signals with a nominal 20 bit resolution data in band.

Considering now filtering, bandshifting and decimation, the signals from the 44 individual ADCs in each electronics module feed to a collection of Field Programmable Gate Arrays (FPGAs). The four FPGAs per module each process 11 transducer channels and are configured by firmware to carry out the necessary filtering process to extract the high precision data in the receive band from the over-sampled data from the noise shaping modulators. The signal flow used for this process is shown in FIG. 16. The 8 bit over-sampled data is first filtered and decimated by a factor of 12 using a cascade of decimated finite impulse response (FIR) filters. The decimated data, now at a 1.6667 MHz sample rate with a word length of 17 bits is then multiplied by a complex bandshifting sequence to base-band the data. The resultant complex (i.e. real/imaginary) bandshifted data is further decimated by a factor of 8 using decimated FIR filters. This data is further processed by a cascade of two proprietary Wave Digital Filter (WDF) sections, that produce 24 bit complex data at a 52.08333 kHz complex sample rate. The WDFs provide the main filtering function in the signal flow, they provide out of band rejection of greater than 120 dB, with virtually no in band ripple and with steep pass band to stop band transition. WDF filters were chosen as they provide the most efficient high performance filtering mechanism, being a factor of 5 more efficient than other known solutions.

Suitable WDF techniques are outlined in United States Patent Application US 20050050126, which describes digital signal-processing structure and methodology featuring a time-slice-based digital fabricating engine, and software operating structure operatively associated with that engine structured to operate the engine in a time-slice-based fabrication mode wherein the engine, in a time-differentiated and instantiating manner, functions to fabricate a time-succession of individual, composite wave digital filters. Each of these filters takes the form of (1) a concatenated assembly including one to a plurality of upstream, early-stage, decimate-by-two, signal-processing agencies connected in a cascade series arrangement, with each such agency possessing a first transfer function having a first transition bandwidth, and (2) a single, downstream, later-stage, decimate-by-two, signal-processing agency which possesses a second transfer function having a transition bandwidth which is less than the mentioned first transition bandwidth.

These techniques enable implementation of the signal processing system in low-cost, low-density gate arrays.

The base-banded filtered complex data from the final WDFs form a multiplexed data stream that contains the data from all elements in the array modules. The data streams from each of the modules in the array feed to the wet end hub subsystem, where they are combined and fed via a 1.25 Gbit/s fibre transceiver to the fibre umbilical cable, for transmission to the dry end.

The low power electronics circuits are powered using commercial power supplies that form part of the hub electronics, fed from the 115v, 60 Hz umbilical cable feed.

The umbilical cable is available from LEMO (UK) Limited of Worthing, West Sussex, UK. It provides two separate 1300 nm, single mode fibres, a copper pair for power distribution and a further copper pair that is used to support a dedicated flood alarm system, to warn of any water ingress in the system. Typically this umbilical cable is between 100 m and 1 km in length, depending on where the sonar wet end is to be deployed.

The top end hub interfaces to the umbilical cable and receives the optical data via a 1.25 Gbit/s fibre transceiver. The output from the transceiver feeds to an FPGA system that is firmware programmed to provide local storage of all the data received from the array during the receive cycle, using high density DRAM stores. The FPGA also interfaces to a USB interface that allows the top end computer to access the stored received data and to send various commands to the wet end to cycle the transmission, control the BITE inject sequence, set the system gain, etc. The top end unit also contains the power interface, fed from an isolating transformer, itself fed from a 115v, 60 Hz mains source. The top hub also measures the variation of impedance of an inter-digitated flood sensor mounted in the array enclosure to monitor for possible flooding in the wet end system, sounding an alarm if flooding is detected.

The top end processing will now be discussed, first with reference to beamforming and target echo processing.

Transducer data from the individual elements in the sonar array are received from the 1.25 Gbit/s fibre optic umbilical via a transceiver and fed to the top end hub processing, as described hereinbefore.

Data is stored locally in the hub for the complete receive period. This data is stored element sequentially for each of the transducers in the array, with sufficient samples stored to provide a reasonable surveillance range bracket. For a system bandwidth of 52.08333 kHz, the corresponding sample rate equates to 19.4 μs, so storing 64 k samples provides a time series length of 1.258 seconds, equivalent to a surveillance range bracket of around 930 metres, for a nominal speed of sound in the water of 1490 m/s. This range bracket matches well to the detection performance of the system. The time used to start gathering these time history blocks can be offset by the operator. Thus, the usable 930 metres range bracket can, for example, be set to provide surveillance cover extending 930 metres from the array or can be offset to provide an annular surveillance range cover extending from X m to (X+930) m, where X can be selected by the operator.

The 64 k complex samples for each transducer in the array are stored in local SDRAM in real time as they are processed by the wet end electronics. This received data is read across to a desktop PC, via a USB2.0 interface, in non-real time, so the hub data store provides an elastic buffer to allow for the asynchronous operation of the top and bottom end processes. The data read by the PC via the USB interface is stored in the PC memory as a 2-D matrix, with the 64 k complex time samples stored in time order for each of the transducers in the array sequentially. Data at this stage is 24 bit complex fixed point format and the first signal processing operation is to convert the fixed point data matrix to 32 bit complex floating point, to minimise truncation and rounding effects in the downstream processing. The floating point data is written back into a time-space matrix, with similar format to that outlined for the fixed point data and the signal processing functions to beamform the data and to extract target echoes performed. However, spare slots are left in the 2-D matrix for the “missing channels” between each array module and also any channels that test as faulty by the BITE system are zeroed out.

An interpolation process is then carried out to approximate the data values in the missing and faulty channels using a FIR spatial filter across adjacent transducer signals. This interpolation process is essentially a lumped, linear bilateral process and could therefore be applied at a number points in the overall processing flow. It is described here for convenience but could equally well be performed later in the process flow, for example, in the frequency domain rather than in the time domain as here.

The major beamforming and echo processing DSP functions are performed on this interpolated data matrix as shown in the top level block schematic of the processing signal flow outlined in FIG. 17, which illustrates pseudo-circular 360 point convolution FFT beamforming with replica correlation. In FIG. 17: 64 k fast Fourier transform×360 channels is indicated diagrammatically at 90; 64 k vector multiplication×360 channels is indicated diagrammatically at 92; 360 point circular convolution×64 k cells is indicated diagrammatically at 94; and 64 k inverse fast Fourier transform×360 channels is indicated diagrammatically at 96.

As noted hereinbefore, the present invention provides beamforming by means of a circular convolution with the array wave function, rather than the FDFT approach of my 1998 paper Wide band, high resolution sonar techniques, ibid. More particularly, the process flow of the present invention is FFT, Vector Multiply, Circular Convolution, IFFT, which contrasts with the flow FFT, FDFT, Vector Multiply, IFFT of 1998.

The signal processing operation uses a collection of time and frequency domain processes. It wraps the correlation processing for echo extraction around the frequency domain beamforming process in order to minimise the overall processing load. The operation is as follows.

(a) The 64 k complex floating point time series block for each channel in turn is converted into the frequency domain using a high performance proprietary FFT algorithm.

(b) The complex frequency domain data vector for each channel is multiplied by the complex conjugate, frequency domain version of the transmitted pulse to perform a circular correlation of the received time series data with the transmit waveform to extract echo data.

(c) The resultant frequency domain correlated channel output vectors are written back in place into the 2-D storage matrix.

(d) The 2-D matrix is then addressed in the orthogonal direction (i.e. corner turned) and the 360 complex frequency domain samples for each of the 64 k frequency cells in sequence are fed to an FFT based process that convolves the 360 samples of element data across the array for that particular frequency cell with a frequency domain version of the array wave function at that particular frequency, to form a fan of 360 individual receive beams from the array. This beamformed data is written back in place into the 2-D matrix.

(e) The 2-D matrix is then read in the frequency direction and the 64 k complex correlated samples are inverse Fourier transformed, using a proprietary FFT algorithm, to convert the beam data back into the time domain. This IFFT process is repeated for all 360 frequency domain beams to generate the required fan of 360 beams in the time domain.

(f) The complex time series beam data is then converted to magnitude form and passed to the tracking and display processes.

(g) The beam magnitude data can at this stage be displayed to the operator to provide a raw detection display but in practice it is necessary to add at least some echo association processing to ensure that moving targets of spatial extent similar to the perceived threat are displayed preferentially. These association processing and raw detection display functions in the top end processing will now be discussed in more detail

The magnitude beam data produced by the signal processing can be used to provide a raw detection data display. In order to show the perceived threat type clearly, additional data processing is required to extract echoes that have metrics matching the threat class. Thus, the processing chain used on the raw magnitude beam data streams is as follows.

(a) Associate echo clusters by collapsing the 64 k data samples, which provide a resolution in the radial range direction of approximately 1.4 cm, to preferentially show targets with range extents approaching 1 metre, matching more closely those of a swimmer or diver.

(b) Calculate the log-magnitude of the collapsed data.

(c) Associate echo clusters from succeeding transmissions by feeding them into a space-time store with a fading memory. The basic algorithm employed here is to use a 2-D matrix store, which maps directly to the surveillance cover. On each successive ping cycle, compare the processed echo cluster with the data in the fading memory store. If the new echo cluster signal is greater than that stored in the fading memory, use the new signal to over-write the old data, if it is smaller, reduce the value stored in the fading memory store by some fading factor. In this way, target clusters that move are associated in the store and over time show up as tracks in the fading memory store. The fading track mechanism provides a degree of process gain due to the incoherent integration process involved and the dynamic metrics of the track can provide clues to the target classification.

(d) Normalise this log-magnitude data to calculate the local signal-to-noise ratio.

(e) Map the orthogonal axes of the fading memory store to the radial axes of the surveillance bracket and display.

Typical resultant detections from this fading memory store are shown in FIGS. 18 and 19, which reproduce displays from a test installation, using as target a diver equipped with a closed cycle rebreather SCUBA. In FIG. 18, a diver has been detected, in a position indicated by the circle 100, at a range of 740.97 m and a bearing of 14.5°, with a fading track showing the diver coming in from 830 m. The display of FIG. 19 shows that the diver has moved to a new position 102, at a range of 285.33 m and a bearing of 34.1°, showing the track of the diver coming in from 400 m. It will be noted that the diver is detected effectively despite a large amount of clutter caused by extraneous echoes from fish and other subsea items. It should be noted that these are results from an actual in-sea test and do not reflect the maximum range and detection performance of the system.

There now follows a discussion of the tracking and classification processing.

The raw magnitude data generated from the processes described hereinbefore can be input to a proprietary tracking and classification software package using Kalman filter techniques to cluster target-like echoes and to track them with time. As above, track metrics are used to classify likely target types using the dynamics of the detected target movement to define possible threat types.

The results from this tracking and classification process are shown overlaid on the fading memory detection data in FIG. 20. This shows the track of the swimmer shown in FIGS. 18 and 19 in arriving at the position 102.

The present invention offers a number of significant improvements over the FDFT approach of my 1998 paper Wide band, high resolution sonar techniques, ibid, inter alia as follows.

(a) The FDFT approach is efficient only with element numbers such as 256 or 512, which match efficient FFT block lengths. The pseudo-circular convolution algorithm is efficient for element numbers of say 360, and thus matches better to the practical limits used in many operational systems.

(b) The curvature required for processing a cylindrical array as in the present invention is much more than that used in the past with conformal arrays. Whilst this could in principle be accommodated using FDFT, it would impose constraints on the number of elements in the cylindrical array, and the use of the rotationally symmetric wave function as in the present invention is numerically more efficient with other array sizes.

(c) The pseudo-circular convolution algorithm of the present invention is much more efficient in terms of number crunching requirements than the FDFT approach.

(d) Implementation by means of a fast convolution wave function greatly simplifies the mathematics of the beamformer realisation and very substantially reduces the amount of hardware—and hence the cost—needed to implement the overall system. For instance in 1998 we referred to the use of Butterfly Complex

Vector Processors, of which six might be required at say £20,000 each; but the present invention can perform the equivalent function (using pseudo-circular convolution instead of FDFT) with a single CPU which can be bought off the shelf for about £130.

Those skilled in the science will now appreciate that the invention provides an underwater intruder detection system particularly appropriate for spotting enemy combatants, insurgents and terrorists seeking to attack civilian or military facilities by underwater assault.

The description set forth hereinbefore is intended to describe the best method of performing the invention known to the applicants, but it should be understood that various modifications and adaptations may be possible.

1. An underwater surveillance system including:
a sensor array subsystem configured and arranged for immersion in a body of water to transmit and receive sonar signals and comprising a plurality of piezoelectric elements arcuately spaced apart azimuthally around an angle θ;
a data acquisition subsystem operatively connected to the sensor array subsystem to digitise data therefrom; and
a beamforming subsystem operatively connected to the data acquisition subsystem;
wherein the beamforming subsystem is operative to process outputs of the sonar array subsystem by means of a pseudo-circular convolution technique thereby to form defined beams.

2-22. (canceled)

23. A beamformer for forming defined beams by processing signals from a sensor array, wherein said beamformer includes pseudo-circular convolution means for processing said signals.

24. A beamformer as claimed in claim 23 wherein said beamformer includes replica correlation processing operative by fast convolution of complex blocks of data from each element of the sonar array subsystem to form multiple receive beams.

25. In a beamformer as claimed in claim 24, a method of processing the blocks of data comprising the steps of:
(a) transforming the time-domain data block into a plurality of cells in the frequency domain by means of a 64 k point fast Fourier transform (FFT),
(b) fast replica correlation by means of 64 k point vector multiplication of each of the frequency domain data block outputs,
(c) fast pseudo-circular convolution implemented across the elements for each frequency cell, thereby to generate frequency domain beam data, and
(d) 64 k point inverse FFT (IFFT) to return to the time domain.

26. An underwater surveillance system including:
a sensor array subsystem configured and arranged for immersion in a body of water to transmit and receive sonar signals and comprising a plurality of piezoelectric elements arcuately spaced apart azimuthally around an angle θ;
a data acquisition subsystem operatively connected to the sensor array subsystem to digitise data therefrom; and
a beamforming subsystem operatively connected to the data acquisition subsystem;
wherein the beamforming subsystem comprises a beamformer as claimed in claim 23 operative to process outputs of the sonar array subsystem and thereby form defined beams.

27. An underwater surveillance system as claimed in claim 26 wherein:
the array comprises P hydrophones and the beamformer is configured and arranged to form P contiguous beams from an arc of the array comprising Q said hydrophones;
Q is less than P; and
P+Q is less than or equal to an integer power of 2.

28. An underwater surveillance system as claimed in claim 27 wherein P=360 and Q≦152.

29. An underwater surveillance system as claimed in claim 26 wherein the data acquisition subsystem comprises multiple continuous-time band-pass sigma-delta noise shaping modulators using multibit feedback architecture and decimated finite impulse response and wave digital filter sections.

30. An underwater surveillance system as claimed in claim 29 wherein the wave digital filters provide out of band rejection of greater then 120 dB, with in band ripple less than 0.1 dB and with a pass band to stop band transition bandwidth less than 4 kHz.

31. An underwater surveillance system as claimed in claim 30 wherein the data acquisition subsection dissipates less than 150 mW per channel whilst maintaining 20-bit precision.

32. An underwater surveillance system as claimed in claim 26 wherein the sensor array is divided into a plurality of sectors configured and arranged to provide a specified azimuthal spread, each said sector having an angular dimension of 45° in azimuth.

33. An underwater surveillance system as claimed in claim 26 wherein the sensor array comprises a 1-3 piezo-composite material impedance matched to the water.

34. An underwater surveillance system as claimed in claim 33 wherein the piezo-composite material is curved by a kerfing process entailing preferentially cutting wider kerfs between active transducer areas.

35. An underwater surveillance system as claimed in claim 26 wherein the multiple receive beams are azimuthally narrow, whereby the system provides high angular resolution.

36. An underwater surveillance system as claimed in claim 35 wherein the azimuthal beamwidth of each beam is 1°.

37. An underwater surveillance system as claimed in claim 36 wherein the elevational beamwidth of each beam is 10°.

38. An underwater surveillance system as claimed in claim 26 wherein the system operates at about 100 kHz and the sonar array has dimensions of about 850 mm horizontally and 85 mm vertically.

39. An underwater surveillance system as claimed in claim 26 wherein the data acquisition subsystem includes digital filtering and decimation implemented in field-programmable gate array (FPGA) form.

40. An underwater surveillance system as claimed in claim 26 wherein the system includes a power amplification subsystem operatively connected to the sensor array subsystem and configured and arranged to deliver thereto at least 215 dB relative to μPa at 1 m.

41. An underwater surveillance system as claimed in claim 26 wherein the system includes:
a detection processing system operatively connected to the beamforming subsystem and configured and arranged to extract intruder echo data from noise and reverberation;
a display processing subsystem operatively connected to the detection processing subsystem and operative to define tracks from the intruder echo data; and
a display subsystem operatively connected to the display processing subsystem to display intruder images and tracks.
